(19) United States
(12) Patent Application Publication
(10) Pub. No.: US 2026/0295874 A1
(43) Pub. Date: Oct. 1, 2026

(54) Structure of hairdresser scissors and method for its use

(71) Applicant: Cristian Nanni, Pesaro (IT)

(72) Inventor: Cristian Nanni, Pesaro (IT)

(21) Appl. No.: 19/489,364

(22) PCT Filed: Jul. 4, 2024
(86) PCT No.: PCT/EP2024/068844

§ 371 Date: Dec. 2, 2025

(30) Foreign Application Priority Data
Jul. 10, 2023 (IT) 102023000014310

(51) Int. Cl. B26B 13/20

(52) U.S. Cl. CPC B26B 13/20

(57) ABSTRACT

A structure of hairdresser scissors having two first levers defining two cooperating blades on resistance arms, a fulcrum, and two gripping branches on power arms that include rings, one bearing two anatomical prongs and an external thickening therebetween, pivoted on the respective gripping branches and hinged at apices of divergings of the gripping branches.

Outwardly arched appendages extend from the gripping branches by at least one quarter of the overall extension of the power arms. A method of use includes inserting fingers within the rings; supporting, in in the gulf defined by the prong and by the thickening outside one ring, the middle finger of the user; abutting the little finger against the downward prong of the ring; and actuating the outward arched appendages of the power arms as a lever handle with the index finger of the user to set, guide and hold any inclination of the scissors.

### DETAILED DESCRIPTION

### Field of the Art

When cutting hair, hairdressers always have their hands very high, continuously rotating their shoulder, elbow, arm and hand, to follow—with the scissors—the shape of the head of the customer and perform—thereon—the cutting angle that is contingently necessary or appropriate for the haircut to be performed.

This type of posture demands effort on the joints of the neck, shoulder, elbow, arm and hand, causing musculoskeletal problems to the upper limbs and in particular the cervicobrachial region—cervicobrachialgia—with ensuing neck pains, joint pains, radicular pains, carpal tunnel.

In order to manage this actual occupational disease tools, and in particular scissors, whose gripping is capable of taking various inclinations, with the aim of transferring the anatomical movements to the tool, therefore reducing these movements and resulting in less stress to the upper limbs of the operator, have been designed.

Examples of such scissors modified in the handle to facilitate the degree of inclination thereof without jeopardising the limb of the operator are outlined in the European patent No. EP2961578B1 and by the United States patent application No. US2018141222A1 and also International patent application pubblication No. WO2018/231683A1 of 20 Dec. 2018 in the name of Marc Paul Milman, United States patent application pubblication No. US 2006/010695A1 of 19 Jan. 2006 in the name of Wu Shu-Ling, German patent application pubblication No. DE3830934A1 of 22 Mar. 1990 in the name of Pietro Poggetti, German patent application pubblication No. DE3928859A1 of 14 Mar. 1991 in the name of Pietro Poggetti, U.S. Pat. No. 5,125,159A of 30 Jun. 1992 in the name of Billy H. Brenton and others, German utility model No. DE8801248U1 of 24 Mar. 1988 in the name of Stahlwaren Bracht Gmbh & Co.

### Objects of the Invention

In this context, the main object of the present invention is to provide an innovative structure of hairdresser scissors, and technique for its use, that allows the complete, practical and easily controllable inclination of the blades with respect to the gripping and in particular with reference to the gripping rings, so as to transfer onto the tool—the operative torsions, lifting them along with the limbs of the operator, therefore reducing the stresses on the limbs, with the resulting fatigue and occupational diseases stemming therefrom.

Another object of the present invention is to achieve the preceding object through a solution concept that maximises the operative stability of the tool regardless of the orientation in use.

Yet another object of the present invention is to achieve the preceding objects through a concept solution that maintains the contingently required position without changing the use configuration, but which—at the same time—can be easily and promptly changed in the configuration thereof depending on the operative needs.

Another object of the present invention is to achieve the preceding objects through a concept solution that does not jeopardise the multiple techniques for gripping the rings of the professional hairdresser scissors.

Still another object of the present invention is to achieve the preceding objects through a solution concept that is simple and efficient, safe in use and a relatively economic cost considering the results practically attainable therewith.

### Summary of the Solution Concept

These and other objects are all achieved by the structure of hairdresser scissors and relevant method of use, according to the present invention as defined by the claims, of the type with two combined first type levers (2A, B) which are hinged to the fulcrum (3) to define two cooperating blades (4A, B) on the resistance arms (4A, B) and two gripping branches (5A, B) on the power arms (5A, B), comprising—on the gripping branches (5A, B)—respective rings (7A, B) of which one (7B) bears two external anatomical prongs (15, 16) and an external thickening (17) between them for inserting the fingers (8,10,11,14) pivoted on the respective gripping branches (5A, B) rotating on respective axes (ya, b) both transversal to the axis (x) of the scissors (1) fulcrumed at the apices of the divergings (6A, B) of the gripping branches (5A, B) which extend—at the rear part—to the rotation axes (ya, b) of the rings (7A, B) on the side opposite to the fulcrum (3) through outwardly arched appendages (18A, B) dimensioned extending for a portion of axis (x) of the scissors (1) by at least one quarter of the overall axial dimensional extension of the power arms (5A, B) on the axis (x) of the scissors (1). And by the method according to the present invention as defined by the claims in which within the ring (7B) with the two external anatomical prongs (15, 16) and an external thickening (17) between them is inserted the ring finger (11) of the user; in the gulf defined by the prong (15) and by the thickening (17) outside the ring (7B) is received and supported the middle finger (10) of the user; against the prong (16) outside the ring (7B) abuts the little finger (14) of the user; the outward proximal appendages (18A, B) of the power arms (5A, B) are actuated as a lever handle by the index finger (9) of the user to set, guide and hold any inclination of the scissors.

### DESCRIPTION OF THE ATTACHED DRAWINGS

Further characteristics and advantages of the structure of hairdresser scissors according to the present invention will be more apparent from the following detailed description of a preferred but non-exclusive relative embodiment, represented solely by way of non-limiting example in the six attached drawings, wherein:

FIG. 1 shows a structure of hairdresser scissors according to the present invention in the diverged extension thereof, in plan view;

FIG. 2 shows a structure of hairdresser scissors according to the present invention in the closed extension thereof, in plan view;

FIGS. 3 to 8 included respectively show equally exemplifying operative positions of the structure of hairdresser scissors according to the present invention.

### STATIC DESCRIPTION OF THE EMBODIMENT

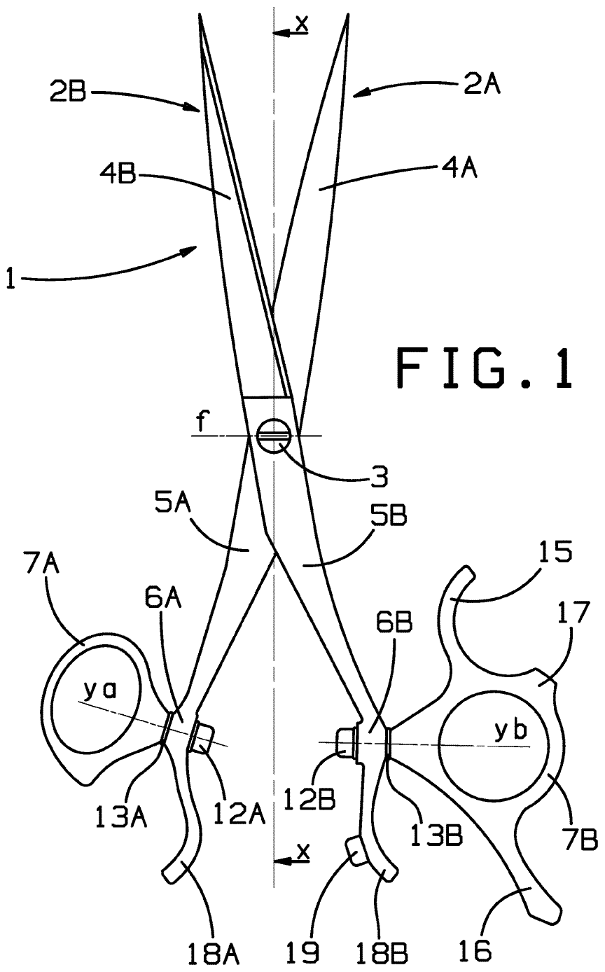

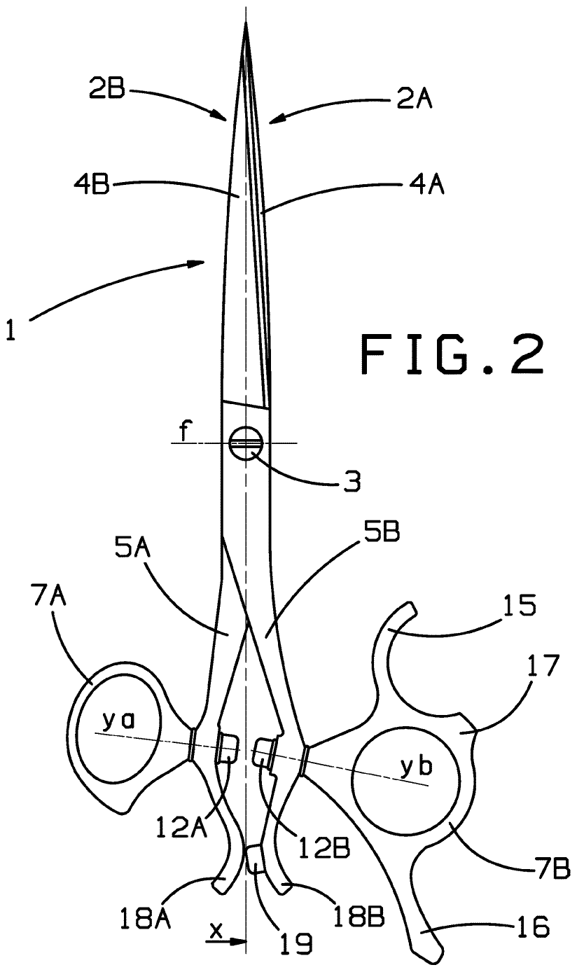

With reference to the figures and in particular to FIG. 1 the structure of hairdresser scissors according to the present invention, based on the physics principle of the double lever of the first kind, whose fulcrum 3 lies in the central pin 3, with a cutting plane p perpendicular to the axis of the fulcrum f substantially median to the pin 3 of the pivot 3 is indicated in its entirety with 1

The two paired first type levers are indicated in their entirety respectively with 2A and 2B, twinned to the fulcrum 3 by a hinge 3 to define two cooperating blades 4A and 4B on the resistance side, blades forming the resistance arms 4A and 4B, and two gripping branches 5A and 5B on the power side, gripping branches forming the power arms 5A and 5B.

The power arms or gripping branches 5A and 5B are shaped diverged on the cutting plane with respect to the axis x of the scissors 1.

At the top of the mutual diverging 6A and 6B, the power arms or gripping branches 5A and 5B respectively support-externally pivoted-the ring 7A for the insertion of the thumb 8 and the ring 7B for the insertion of another finger and typically the ring finger 11 of the user's hand.

The rings 7A and 7B are supported-rotatably pivoted-in the first 5A and in the second 5B power arm or gripping branch of the first 2A and second 2B lever:

first power arm 5A outwardly rotatably supports the ring 7A through a transverse screw 12A passing through the first power arm 5A through a bushing 13A with respect to which the transverse screw 12A can be tightened to increase the rotational resistance of the ring 7A until it is locked.

The second power arm 5B outwardly rotatably supports the ring 7B through a transverse screw 12B passing through the second power arm 5B, through a bushing 13B with respect to which the transverse screw 12B can be tightened to increase the rotational resistance of the ring 7B until it is locked.

The rings 7A and 7B are rotatable on the respective power arms 5A and 5B on respective axes ya and yb substantially coplanar or parallel to the cutting plane p and transversal to the axis x of the scissors 1

the rotation axes ya and yb of the rings 7A and 7B can be orthogonal to the axis x of the scissors 1

alternatively, the rotation axis ya and yb of the rings 7A and 7B may be inclined with respect to the axis x of the scissors 1, preferably by angles ±30° with respect to the axis orthogonal to the axis x of the scissors 1.

The ring 7B of the ring finger 11 carries two external anatomical prongs 15 and 16 and an external thickening 17 between them.

In use, the ring finger 11 of the user is inserted into the ring 7B,

the middle finger 10 is received and supported in the gulf defined by the prong 15 and by the thickening 17 outside the ring 7B,

the little finger 14 abuts against the prong 16;

the index finger 9 is free to adjust the inclination of the blades 4A and 4B acting on the outward appendages 18A and 18B, as mentioned hereinafter.

In this manner, three fingers support the scissors 1 fully and in a balanced fashion, providing for all movements and inclinations of the tool, excluding the diverging and closing of the blades 4A and 4B, that is the cutting which is carried out by the thumb 8 in the ring 7A.

The power arms 5A and 5B proximally carry outward appendages 18A and 18B at the end of their mutual symmetrical diverging 6A and 6B, with an end-of-stroke abutment protrusion 19 internally fixed to the appendage 18B for abutting against the appendage 18A.

The outward appendages 18A and 18B of the gripping branches 5A and 5B extend—at the rear part with respect to the rotation axes ya and yb of the rings 7A and 7B—on the side opposite to the fulcrum 3 dimensioned extending for a portion of axis x of the scissors 1 by at least one quarter of the overall axial dimensional extension of the power arms 5A and 5B on the axis x of the scissors 1 for the purposes outlined hereinafter.

### DYNAMIC DESCRIPTION OF THE EMBODIMENT

Thus, having completed the static description of preferred embodiments of the structure of hairdresser scissors according to the present invention, below is the dynamic description, or the relative operation, which also coincides with the procedure of relative use:

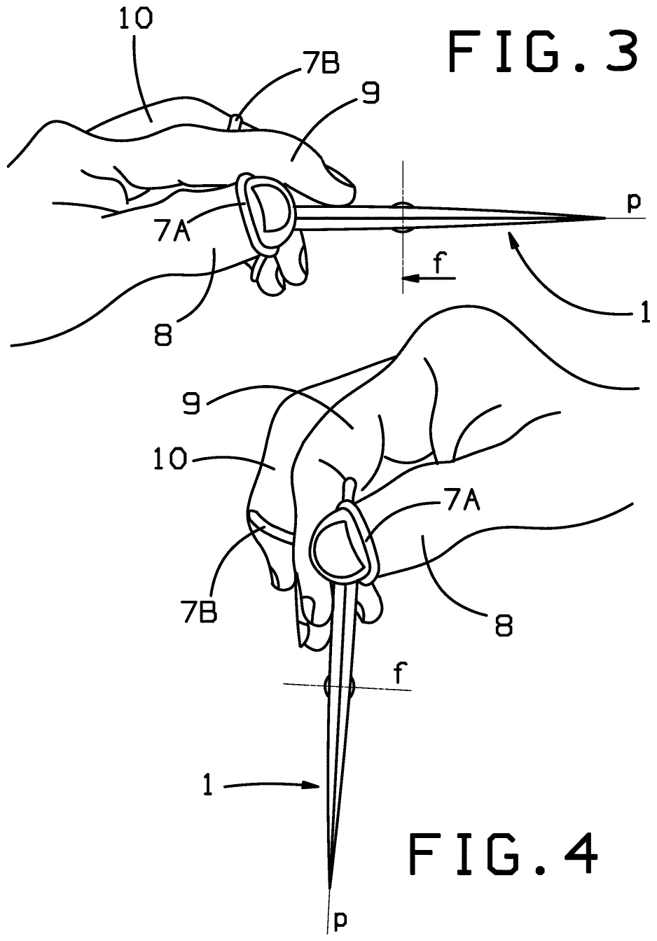

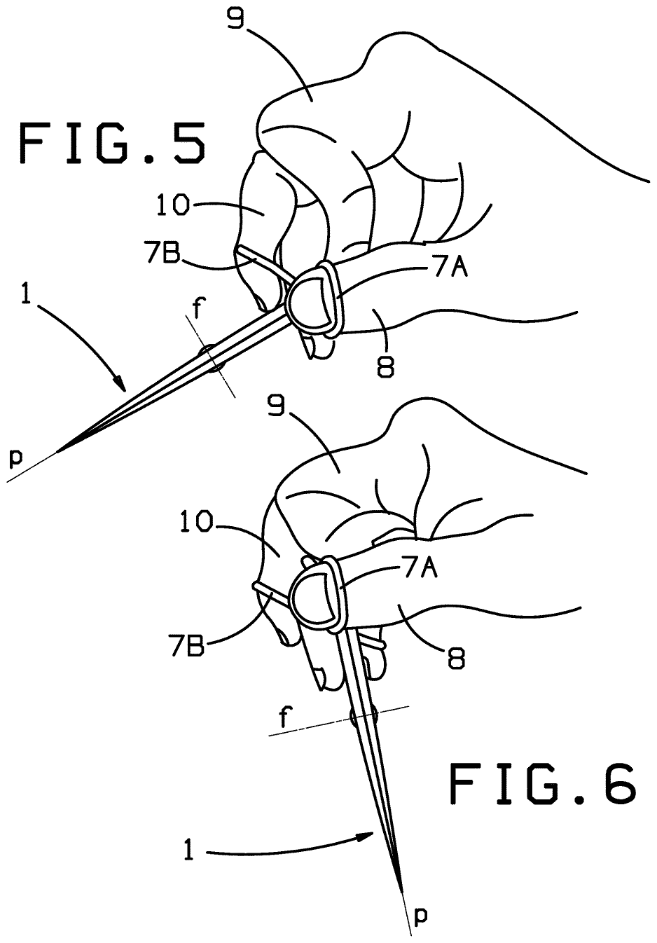

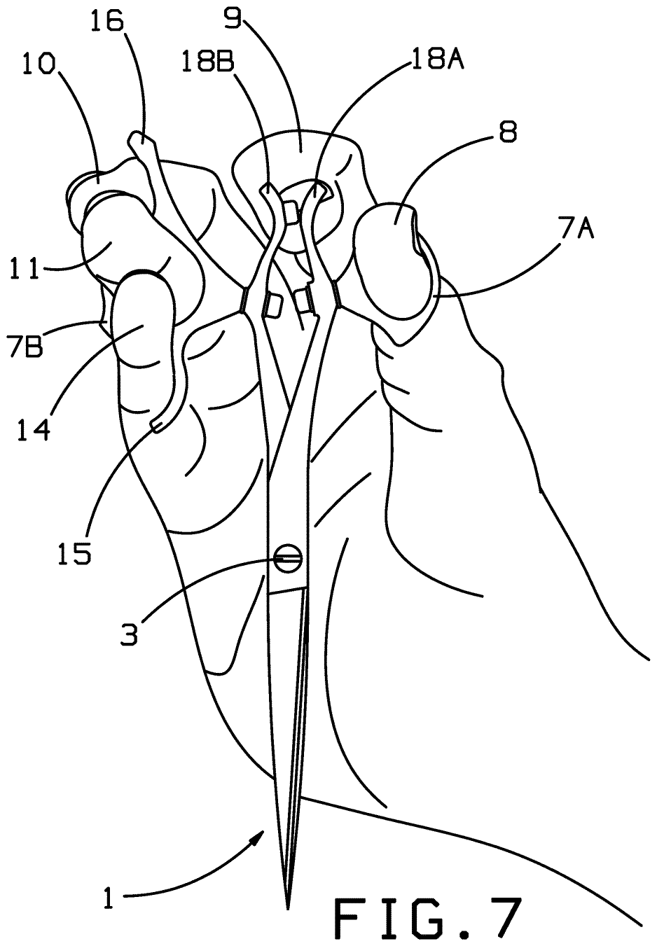

FIGS. 3 to 8 included show an equal number of views of alternative gripping options of the structure of scissors 1 according to the present invention:

they clearly show that, considering the same posture of the hand of the operator, the orientation of the cutting plane p of the scissors 1 may be varied in the six exemplifying inclinations shown therein and in any intermediate or further inclination.

The variation is achieved thanks to the change in the configuration of the scissors 1 with respect to the relative gripping rings 7A and 7B, with which the fingers 8, 9, 10, 11 and 14 of the hand of the operator, whose posture in the space may remain substantially tendentially fixed, interact.

This change of configuration is carried out and controlled by the index finger 9 acting on the body of the scissors 1 and in particular on the rear gripping means 18A and 18B and the rotation of the gripping rings 7A and 7B ya and yb is enabled on axes both of which are transversal to the axis x of the scissors 1 and of the power arms 5A and 5B of the first type levers 2A and 2B which form the scissors 1.

Therefore, with the fixed posture of the operator, this may allow to achieve any inclination of the cutting plane p, controlled by the operator with an action of the index finger 9 on the rear appendages 18A and 18B between the gripping rings 7A and 7B, and adjusted-in terms of firmness-by tightening the screws 12A and 12B until the desired operative resistance of the hand on the tool 1 is achieved.

The outward appendages 18A and 18B of the gripping branches 5A and 5B extend—at the rear part with respect to the rotation axes ya and yb of the rings 7A and 7B—on the side opposite to the fulcrum 3, dimensioned extending for a portion of axis x of the scissors 1 for a segment by at least one quarter of the overall axial dimensional extension of the power arms 5A and 5B on the axis x of the scissors 1.

This kind of conformation and a such dimensioning of the outward appendages 18A and 18B of the gripping branches 5A and 5B allow an appropriate gripping and lever arm on the index finger 9 of the operator, so as to change the inclination of the scissors 1 with respect to the gripping rings 7A and 7B which remain oriented with the hand;

therefore, while the hand with the rings remain substantially oriented in the same manner in the space and with respect to the body of the operator, whose wrist, elbow and shoulder remain substantially in a fixed and stress-free position, the inclinations that confer the cut and overall shape of the haircut are all carried out by the index with fluidity similar to the mobility of the wrist which is saved instead.

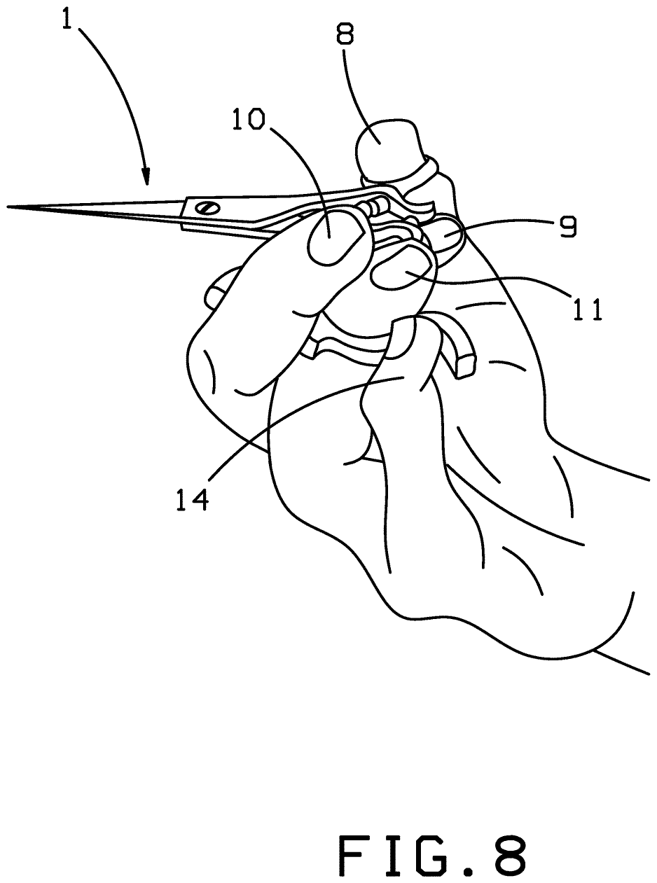

This kind of mobility of the scissors is achieved despite the fixed wrist reaching up to possibility of carrying out the cut with the scissors overturned, as shown in FIG. 8.

At the same time, the three ring 11, middle 10 and little 14 fingers support the scissors 1 fully and in a balanced fashion, providing for all movements and inclinations of the tool set by the index finger 9, excluding the diverging and closing of the blades 4A and 4B, that is the cutting, which is carried out by the thumb 8 in the ring 7A.

### ALTERNATIVE EMBODIMENTS

It is obvious that in further alternative embodiments still falling within the innovation concept subject of the embodiment illustrated above and claimed below, the structure of hairdresser scissors according to the present invention, may be implemented through equivalent technical and mechanical solutions, i.e. provided with further supplementary solutions, just like—in the claimed scope—all elements they are made of may vary in a manner suitable for the purpose and adapted to the specific conformation and structure.

### ADVANTAGES OF THE INVENTION

As observable from the preceding detailed description of a preferred embodiment, the structure of hairdresser scissors according to the present invention, offers the advantages corresponding to the attainment of these and other pre-set objects:

the hairdresser scissors according to the prior art, even where provided with rings articulated on the handle, do not allow an actual fixed posture of the hand and of the upper limbs of the operator in the space, nevertheless achieving any inclination of the cutting plane; actually, they require bending and torsions to achieve practical cuts in the proportions and shapes sought by the operator.

This being due to the fact that they do not have transversal traits of the rotation axis of both rings with respect to the axis of the scissors, the pivoting of the axis transversal to the diverging apex of the power arms, an extension of the power arms which is rear with respect to the rotation axis of the rings on the side opposite to the fulcrum extended by at least one quarter of the overall extension of the power arms, the outward arching of such extensions.

As a whole, these characteristics allows the operator to grip the tool with two fingers in the rings and, with at least one intermediate finger, continuously control the inclination of the tool, maintaining it or changing it promptly as needed substantially without any stress on the joints of the wrist, elbow and shoulder.

### KEY TO NUMERAL AND LETTER REFERENCES

1) structure of hairdresser scissors in its entirety
2A) first first type lever
2B) second first type lever
3) central pin/fulcrum
4A) first blade or first resistance arm
4B) second blade or second resistance arm
5A) first gripping arm or first power arm
5B) second gripping arm or second power arm
6A) top diverging of the first gripping arm
6B) top diverging of the second gripping arm
7A) ring for inserting the thumb
7B) ring for inserting the ring finger
8) thumb finger
9) index finger
10) middle finger
11) ring finger
12A) transverse screw passes through the first power arm
12B) transverse screw passes through the second power arm
13A) bushing of the pin passing through the first power arm
13B) bushing of the pin passing through the second power arm
14) little finger
15) first external anatomical prong of the ring of the middle finger
16) second external anatomical prong of the ring of the little finger
17) external anatomical thickening to define a receptacle of the middle finger
18A) outwardly proximal appendage of the first power arm
18B) outwardly proximal appendage of the second power arm
19) end-of-stroke abutment
ƒ) axis of the fulcrum
p) cutting plane
x) axis of the scissors
ya) rotation pivot axis of the first ring
yb) rotation pivot axis of the second ring

The invention claimed is:

1. A structure of hairdresser scissors that includes two combined first levers (2A, B), which are hinged to a fulcrum (3) to define two cooperating blades and comprise two resistance arms (4A, B) and two gripping branches (5A, B) providing power arms
on the gripping branches (5A, B), respective rings (7A, B) for inserting fingers (8, 10, 11, 14), the respective rings being pivoted on the respective gripping branches (5A, B) for rotating on respective rotation axes (ya, b), transversal to an axis (x) of the scissors (1), the gripping branches extending outwardly in a direction away from the fulcrum (3) with two external appendages (18A, B).

2. The structure of hairdresser scissors according to claim 1, wherein one of the rings (7B) bears two external prongs (15, 16) and an external thickening (17) between the two external prongs (15, 16) for housing the fingers (8, 10 11, 14), and wherein the rings (7A, B) are pivoted on the respective gripping branches (5 A, B) on diverging apices (6A, B) of the gripping branches (5A, B) which extend at a rear part thereof with respect to the rotation axes (ya, b) of the rings (7A, B) on an opposite side of the fulcrum (3) through the two external appendages (18A, B), the two external appendages being configured to define, when combined matched twinned, a single projecting handhold for varying an inclination of the scissors.

3. The structure of hairdresser scissors according to claim 1, wherein:
the two first levers (2A, B) are coupled to the fulcrum, which is configured as a hinge to define, at the two resistance arms, two cooperating blades (4A, B) and, on the power arms, defined on the two gripping branches (5A, B) shaped diverged on a cutting plane with respect to the axis (x) of the scissors (1);
a first ring (7A) of the two rings configured for insertion of a thumb (8) and a second ring (7B) o the two rings for insertion of a ring finger (11) of a user's hand, the first ring and the second ring supported externally to be rotatably pivoted at a top of a mutual diverging (6A, B) of the gripping branches (5 A, B);
two anatomical external prongs (15, 16) and an external thickening (17) between the prongs (15, 16) provided on the second ring (7B) for the insertion of the ring finger (11); and
two outwardly arched appendages (18A, B) provided proximally to the power arms (5A, B) at an end of a mutual symmetrical diverging (6A, B) thereof.

4. The structure of hairdresser scissors according to claim 3, wherein:
the first power arm (5A) outwardly rotatably supports the first ring (7A) through a first transverse screw (12A) passing through the first power arm (5A) which can be tightened to increase a rotational resistance of the first ring (7A) until the first ring is locked; and
the second power arm (5B) outwardly rotatably supports the second ring (7B) through a second transverse screw (12B) passing through the second power arm (5B) which can be tightened to increase rotational resistance of the second ring (7B) until the second ring is locked.

5. The structure of hairdresser scissors according to claim 3, wherein the first and the second rings (7A, B) are rotatable on the respective power arms (5A, B) on the respective axes (ya, b) substantially coplanar or parallel to a cutting plane (p) and transversal to the axis (x) of the scissors (1).

6. The structure of hairdresser scissors according to claim 3, wherein the first and the second rings (7A, B) are rotatable on the respective power arms (5A, B) on respective axes (ya, b) substantially coplanar or parallel to cutting plane (p) and orthogonal to the axis (x) of the scissors (1).

7. The structure of hairdresser scissors according to claim 3, wherein the first and the second rings (7A, B) are rotatable on the respective power arms (5A, B) on respective axes (ya, b) substantially coplanar or parallel to a cutting plane (p) and inclined with respect to the axis (x) of the scissors (1) at angles measuring ±30° with respect to an axis orthogonal to the axis (x) of the scissors (1).

8. The structure of hairdresser scissors according to claim 3, wherein the (18A, B) of the gripping branches (5A, B) extend at a rear part with respect to the rotation axes (ya, b) of the rings (7A, B) on a side opposite to the fulcrum (3) and are dimensioned extending for a portion of the axis (x) of the scissors (1) by at least one quarter of an overall axial dimensional extension of the power arms (5A, B) on the axis (x) of the scissors (1).

9. The structure of hairdresser scissors according to claim 3, wherein the first ring (7B). opposite to the second ring (7 A) housing the thumb (8), carries the two external anatomical prongs (15, 16) and the external thickening (17) therebetween.

10. A method for using the structure of hairdresser scissors according to claim 3, comprising:
providing the structure of hairdresser scissors according to claim 3;
inserting the ring finger (11) of a user into the second ring (7B), arranging the middle finger (10) of the user in a gulf defined by a first anatomical external prong (15) and by the thickening (17) extending outwardly from the second ring (7B);
abutting the little finger (14) of the user against a second anatomical external prong (16) extending outwardly from the second ring (7B); and
actuating the outwardly arched appendages (18A, B) of the power arms (5A, B) as a lever handle by the index finger (9) of the user.

11. The method according to claim 10, wherein, in use:
the ring finger (11) of the user remains inserted into the second ring (7B), the middle finger (10) of the user remains received and supported in the gulf defined by the first anatomical external prong (15) and by the thickening (17) extending outwardly from the ring (7B), and the little finger (14) of the user abuts against the second anatomical external prong (16) outside the second ring (7B);
causing the ring (11), middle (10) and little (14) fingers to support the hairdresser scissors (1) fully and in a balanced fashion, providing for all movements of the hairdresser scissors, excluding a diverging and closing of the blades (4A, B) which is carried out by the thumb (8) in the ring (7A); and
actuating, with the index finger (9) of the user, the outward proximal appendages (18A, B) of the power arms (5A, B) to confer any inclination to the hairdresser scissors (1).
